(19) United States
(12) Patent Application Publication
(10) Pub. No.: US 2018/0002092 A1
(43) Pub. Date: Jan. 4, 2018

(54) PREFORMED BAG MADE OF FLEXIBLE PLASTIC MATERIAL AND METHODS FOR PROVIDING A PREFORMED BAG FROM A FILM MADE OF FLEXIBLE MATERIAL WITH A RIGID FRAME

(71) Applicant: COVERIS FLEXIBLES FRANCE, MONTFAUCON.EN.VELAY (FR)

(72) Inventor: Eric Valette, Monistrol Sur Loire (FR)

(21) Appl. No.: 15/547,113

(22) PCT Filed: Jan. 25, 2016
(86) PCT No.: PCT/FR2016/050140

§ 371 Date: Jul. 28, 2017

(30) Foreign Application Priority Data
Jan. 29, 2015 (FR) 1550697

(51) Int. Cl. B65D 77/20; B31B 70/81; B31B 2160/20

(52) U.S. Cl. CPC B65D 77/2076; B31B 70/813; B31B 2160/20

(57) ABSTRACT

The invention relates to a preformed bag (1) which is manufactured continuously from a film of flexible plastic material, in particular PET/PE, with a thickness of less than 200 microns, in order to form a front wall (1a) and a rear wall (1b) assembled at the lateral sides thereof, optionally in combination with gussets (1c) and (1d), a bottom (1e) and a filling opening (1f). A portion of the bag (1) has arrangements for fastening a rigid frame (2), capable of defining an opening communicating with the inside of the bag, said frame being provided with a sealing means (2a).

The invention relates to the technical field of packaging bags made of plastic.

More particularly, the invention relates to a preformed bag made from flexible plastic material, of a thickness of less than 200 microns, comprising a front wall and a rear wall assembled at the lateral sides thereof, optionally in combination with gussets, and defining a bottom and a filling opening. Generally, these preformed bags are manufactured continuously from a single film of plastic material, such as PE optionally with the addition of PP, or else PE with added PET, or any other materials well known to a person skilled in the art, employed, in particular, in the field of food packaging.

The film of plastic material is continuously subjected to successive operations of folding and welding, in order to manufacture a bag with a bottom, two walls that are optionally connected by gussets, and a filling opening opposite the bottom. The outer folds are generally assembled by means of welding lines. The bottom of the bag may be formed continuously, by means of welding, by being folded and attached to one of the walls of the bag. Other embodiments may be envisaged.

In the field of packaging, it has also been proposed to provide the filling opening of the bag, and occasionally the bottom, with a rigid plastic cover. This solution is however limited to bags made from a rigid plastic material or reinforced paper, or alternatively, to rigid or flexible bags of a plastic material that are not manufactured continuously from a single film of plastic material, as shown, but on a filling machine of the FFS type, from a film of a plastic material.

For example, the teaching can be cited from the documents WO 2009/021156 and WO 2010/054226.

From this prior art, the problem to be solved by the invention is to provide a bag, which is already preformed and manufactured from a flexible plastic material, with a rigid frame.

Consequently, the invention relates to a preformed bag which is manufactured continuously from a film of flexible plastic material, in particular PET/PE, with a thickness of less than 200 microns, in order to form a front wall and a rear wall assembled at the lateral sides thereof, optionally in combination with gussets, a bottom and a filling opening. According to a basic characteristic of the invention, part of this bag has arrangements for fastening a rigid frame, capable of defining an opening communicating with the inside of the bag, said frame being provided with a sealing means.

From this basic design, either the frame is attached in relation to the filling opening or the frame is attached to one of the walls.

Advantageously, the sealing means is a lid.

The invention also relates to a method for providing a preformed bag from a film of flexible plastic material, in particular PET/PE, with a thickness of less than 200 microns, with a rigid frame, according to which method:
the plastic film is continuously subjected to successive operations of folding and welding, in order to manufacture a bag with a bottom, two walls connected by gussets and a filling opening opposite the bottom.
the filling opening or the bottom of the preformed bag or any of the walls is arranged to allow the fixing of a rigid frame before the bag is fed to a filling machine or after filling of said bag.

Advantageously, the frame is attached at the filling opening opposite the bottom.

In this embodiment, the positioning and attachment of the rigid frame is performed as follows:
the plastic film is continuously subjected to successive operations of folding and welding, in order to manufacture a bag with a bottom and two walls connected by gussets,
a transverse cut is made in one of the walls at a determined distance corresponding to the required height of the bag,
the open transverse end of the other wall is folded outwards in such a way as to open the gussets and position them flat thus forming a triangle and,
the rigid frame is attached to the edges of the internal face of the folded wall, on the edges of the internal face of the gussets arranged as a triangle, and on the edge of the inner face of the other wall considered along the bottom.

It follows from these characteristics that the positioning of the rigid frame is performed during the bag forming process.

The invention is described below in more detail using the figures of the attached drawings, wherein:

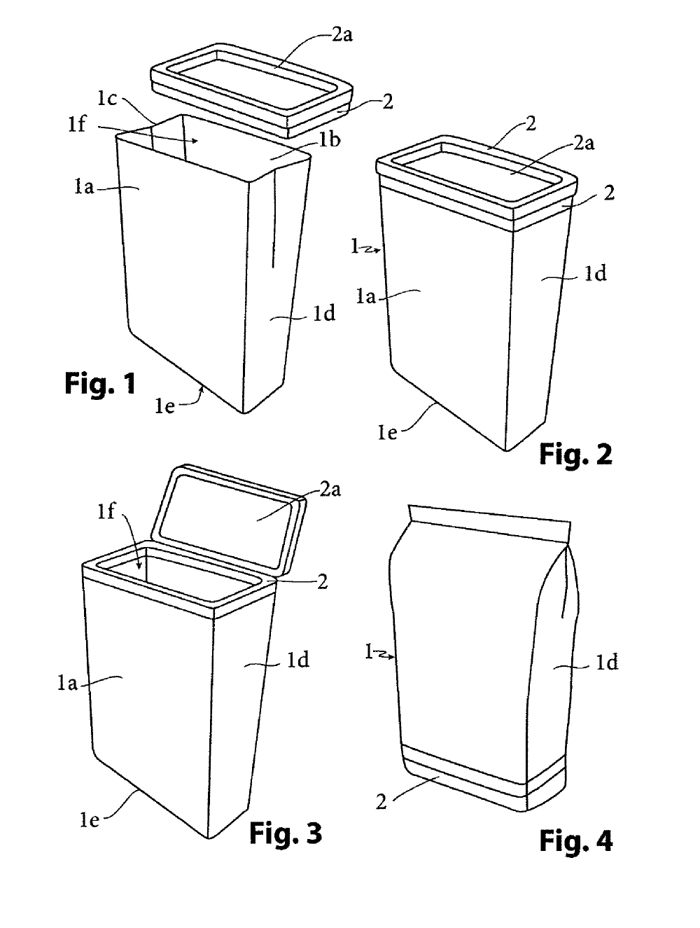

FIG. 1 is a perspective view of a preformed bag made from a flexible plastic material obtained by means of a continuous manufacturing process, and before the positioning of a rigid frame at the filling opening thereof,

FIG. 2 is a view corresponding to FIG. 1 after the positioning of the rigid frame,

FIG. 3 is a view corresponding to FIG. 2 showing the opening of a lid fitted to the rigid frame,

FIG. 4 is a perspective view of a preformed bag made from a flexible plastic material, wherein the bottom is provided with a rigid frame.

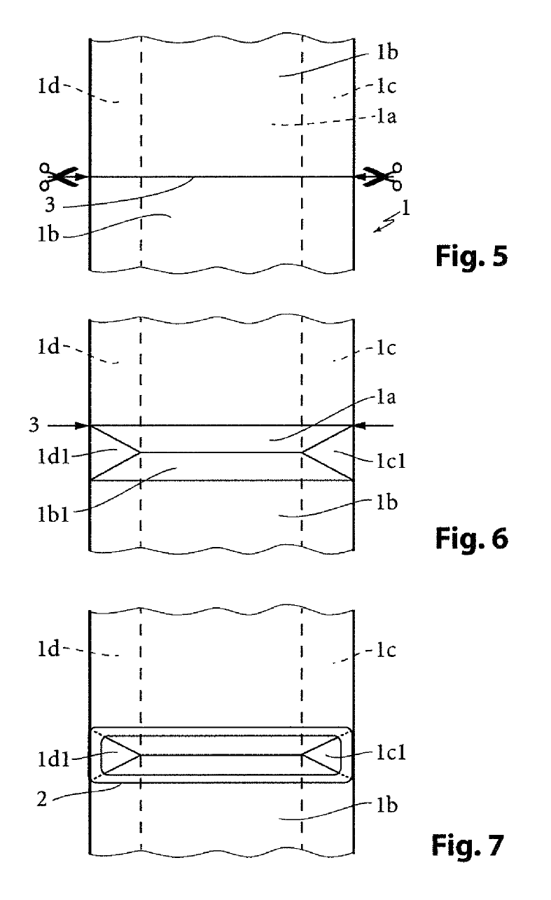

FIGS. 5, 6 and 7 are schematic figures, showing the principle of placing and attaching the rigid frame, at the opening of the bag as it is progressively formed.

As indicated, the invention applies to all types of preformed bags made from a flexible plastic material, of a thickness of less than 200 microns, and obtained from a reel of film continuously unwound, and subjected to various operations, particularly automatic folding and welding.

In other words, with this manufacturing process, the packaging bag is formed before being filled, as opposed to plastic bags obtained on a machine of the FFS type, that is to say, manufactured from of a vertical sleeve, the bag as such, being manufactured as it is progressively filled.

In a perfectly known way, the bag designated as a whole by (1) is manufactured, as indicated, from all types of flexible plastic material of a thickness of less than 200 microns and comprising a front wall (1a) and a rear wall (1b) assembled at the lateral sides thereof, in combination with gussets (1c) and (1d). Furthermore, the bag (1) has a bottom (1e) and a filling opening (1f).

According to the invention, part of the bag (1), which is consequently preformed, has arrangements for fastening a rigid frame (2), capable of defining an opening communicating with the inside of the bag. The frame (2) may, advantageously, be provided with sealing means (2a).

In a preferred way, the frame (2) is attached at the opening (1f). Without departing from the scope of the invention, not excluded is the attachment of the frame (2), in relation to the bottom (1e) (FIG. 4), or to one of the walls (1a) and/or (1b), which wall/s has (have) in this case weakening cuts in order to create an opening corresponding to the geometry of the frame (2).

The frame (2) is advantageously provided, as shown, with sealing means (2a), of the lid kind. With reference to FIGS. 1, 2 and 3.

It follows, therefore, from these characteristics that the method for providing a preformed bag, from a film of flexible plastic material, in particular PET/PE, with a thickness of less than 200 microns, with a rigid frame (2), comprises the following essential steps:
the plastic film is continuously subjected to successive operations of folding and welding, in order to manufacture the bag (1) with the bottom (1e) and the two walls (1a) and (1b), connected by means of the gussets (1c) and (1d), and a filling opening (1f) opposite the bottom (1e).
the filling opening (1f) or the bottom (1e) of the preformed bag or any of the walls (1a) and (1b) is arranged to allow the fixing of a rigid frame (2).

In another advantageous embodiment, the rigid frame (2) is attached at the filling opening of the bag.

For this purpose, the plastic film is continuously subjected to successive operations of folding and welding, in order to manufacture the bag with the bottom (1e), the two walls (1a) and (1b) connected by means of the gussets (1c) and (1d).

A transverse cut (3) is made in of one of the walls (1b) at a determined distance from the bottom corresponding to the required height of the bag.

The open transverse end of the other wall (1a) is folded outwards in such a way as to open the gussets (1c) and (1d) and position them flat thus forming a triangle (1c1) and (1d1). The frame (2) is then attached, by any known and appropriate means, to the edges of the internal face (1b1) of the folded wall (1b) on the edges of the internal face of the gussets arranged as a triangle (1c1) and (1d1), and on the edge of the inner face along the bottom (1e) of the uncut wall (1a). With reference to FIGS. 5, 6 and 7.

The frame (2) has a generally rectangular shape. The length thereof corresponds substantially to the width of the bag, while the width thereof substantially corresponds to the width of the gussets (1c) and (1d).

It follows, therefore, from this manufacturing method, that the positioning of the rigid frame is performed as the bag is continuously forming, after cutting one of the walls, and after opening the gussets at the transverse cut implemented on only one of the walls of the bag.

Clearly, therefore, the positioning of the rigid frame (2) is performed continuously as the bag is being manufactured from a flexible plastic material, of a thickness of less than 200 microns.

The advantages are apparent from the description.

1-8. (canceled)

9. A preformed bag manufactured continuously from a film of flexible plastic material with a thickness of less than 200 microns to form a front wall and a rear wall assembled at the lateral sides thereof, a bottom and a filling opening, wherein the front wall and rear wall are optionally assembled at the lateral sides thereof in combination with gussets, wherein a portion of the bag has arrangements for fastening a rigid frame capable of defining an opening communicating with inside the bag, said frame being provided with a sealing means.

10. The preformed bag according to claim 9 wherein the plastic material comprises PET/PE.

11. The preformed bag according to claim 9 wherein the front wall and rear wall are assembled at the lateral sides thereof in combination with gussets.

12. The preformed bag according to claim 9, wherein the frame is fixed in relation to the filling opening.

13. The preformed bag according to claim 9, wherein the frame is fixed in relation to the bottom.

14. The preformed bag according to claim 9, wherein the frame is attached to one of the walls.

15. The preformed bag according to claim 9, wherein the sealing means is a lid.

16. The preformed bag according to claim 15 wherein the plastic material comprises PET/PE and the front wall and rear wall are assembled at the lateral sides thereof in combination with gussets.

17. A method for providing a preformed bag from a film of flexible plastic material with a thickness of less than 200 microns with a rigid frame, wherein:
the film of a plastic material is continuously subjected to successive operations of folding and welding, in order to manufacture a bag with a bottom, two walls connected by gussets, and a filling opening opposite the bottom, and
the filling opening, the bottom, or any of the walls of the preformed bag is arranged to allow for affixing the rigid frame before the bag is fed to a filling machine or after filling of said bag.

18. The method according to claim 17 wherein the plastic material comprises PET/PE.

19. The method according to claim 17 wherein the filling opening, the bottom, or any of the walls of the preformed bag is arranged to allow for affixing the rigid frame before the bag is fed to a filling machine.

20. The method according to claim 17 wherein the filling opening, the bottom, or any of the walls of the preformed bag is arranged to allow for affixing the rigid frame after filling of said bag.

21. A method for providing a preformed bag of a required height from a film of flexible plastic material with a thickness of less than 200 microns, with a frame, wherein:
the plastic film is continuously subjected to successive operations of folding and welding, in order to manufacture a bag with a bottom, and two walls connected by gussets,
a transverse cut is made in one of the walls at a determined distance corresponding to the required height of the bag,
the other wall is folded at an open transverse end in such a way as to open the gussets and position them flat thus forming a triangle,
the frame is attached to the edges of the internal face of the folded wall, the edges of the internal faces of the gussets arranged as a triangle and on the edge of the inner face of the other wall considered along the bottom.

22. The method according to claim 21 wherein the plastic material comprises PET/PE.
